(19) United States
(12) Patent Application Publication
(10) Pub. No.: US 2010/0297503 A1
(43) Pub. Date: Nov. 25, 2010

(54) POSITIVE ELECTRODE FOR LITHIUM SECONDARY BATTERIES AND LITHIUM SECONDARY BATTERY

(75) Inventors: Kan Kitagawa, Hitachi (JP); Atsushi Ueda, Hitachi (JP); Toyotaka Yuasa, Hitachi (JP); Tatsuya Toyama, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/783,746

(22) Filed: May 20, 2010

(30) Foreign Application Priority Data
May 20, 2009 (JP) 2009-121688

(51) Int. Cl. H01M 4/58

(52) U.S. Cl. 429/231.95

(57) ABSTRACT

A positive electrode for lithium secondary batteries and a lithium secondary battery are provided in which, by using an olivine Mn based positive-electrode active material and an optimal binder for the olivine Mn based positive-electrode active material, peel-off of the electrode and gelatinization of the slurry can be prevented, with large energy density, excellent in rate characteristic and cycle life. The positive electrode includes a positive-electrode composite including at least a positive-electrode active material and a binder; and a positive-electrode current collector. The positive-electrode active material includes a lithium composite oxide having an olivine-type structure, which is represented by the formula LiMnₓM₁₋ₓPO₄ (where 0.3≦x≦1 and M is one or more elements selected from the group consisting of Li, Fe, Ni, Co, Ti, Cu, Zn, Mg, and Zr) . The binder includes an acrylonitrile-based copolymer.

### CLAIM OF PRIORITY

The present application claims priority from Japanese Patent Application JP 2009-121688 filed on May 20, 2009, the content of which is hereby incorporated by reference into this application.

### FIELD OF THE INVENTION

The present invention relates to a positive electrode for lithium secondary batteries and a lithium secondary battery.

### BACKGROUND OF THE INVENTION

Conventionally, lithium cobalt oxide has been a mainstream as a positive-electrode active material for lithium secondary batteries, and the lithium secondary batteries containing lithium cobalt oxide are widely used. However, cobalt, which is a raw material for the lithium cobalt oxide, is low-yielding and expensive, and therefore alternate materials are under consideration. Although the lithium manganese oxide, which has a spinel structure, is considered to be an alternate material, it is insufficient in its discharge capacity and its manganese liquates at high temperatures. The lithium nickel oxide, which is expected to have a high discharge capacity, has a problem in its thermal stability at high temperatures.

From these reasons, the olivine-type lithium phosphate, which has high thermal stability and superior safety, is expected as a positive-electrode active material.

Unfortunately, the olivine-type lithium phosphate is inferior in electron conductivity and ion conductivity. Accordingly, it has a disadvantage that the discharge capacity cannot be fully taken out from it.

To deal with such a disadvantage, in order to improve the electron conductivity and ion conductivity, a technique is proposed in which the diameter of the olivine-type lithium phosphate is made small and thereby an increase in its reaction area and shortening in its diffusion length are realized. However, when a mixture of the active material, conductive additive, and binder has been applied to the current collector, the adhesion between the active materials and that between a current collector and the active material become inferior because an active material has a higher specific surface area with a smaller diameter. Accordingly, a problem occurs that a positive-electrode composite layer peels off from the current collector.

In addition, because the olivine-type lithium phosphate has a one-dimensional diffusion path for the Li ion, the diffusion path may be clogged up and the capacity is decreased when the site exchange (cation mixing) has occurred between Li and different metal ions (such ions as Fe, Mn, Ni, Co, etc.). The cation mixing has also been pointed out in the positive-electrode active materials having a rock-salt structure, such as lithium nickel oxide. The cation mixing has a more significant influence on the olivine-type lithium phosphates, the Li diffusion path of which is one-dimensional, than the active materials having a rock-salt structure, the Li diffusion path of which is two-dimensional. Accordingly, it is necessary to prevent the shielding of the Li sites by using an excessive amount of the lithium source at the synthesis of the olivine-type lithium phosphate. Unfortunately, the olivine-type lithium phosphate is, when synthesized through such a synthesis process, likely to be high alkali due to the remaining lithium salts on the active materials.

Currently, olivine Fe (LiFePO₄) is in practical use among olivine-type lithium phosphates. However, the olivine Fe has a low operating voltage of 3.4 V as well as low energy density. In contrast, the olivine Mn (LiMnPO₄) has a high operating voltage of 4.1 V and can be expected to have larger energy density. Because the olivine Mn is inferior in electron conductivity to the olivine Fe, it is necessary to make the olivine Mn have a higher specific surface area when using as an alternative for the olivine Fe. In addition, because the olivine Mn is also inferior in ion conductivity to the olivine Fe, it is necessary to prevent the cation mixing more strictly. As a result, the olivine Mn is likely to be higher alkali than the olivine Fe.

When using the olivine Mn having such characteristics as a positive-electrode active material for positive electrodes of lithium batteries, it is important to select a preferred binder. If PVDF (polyvinylidene fluoride), which is generally conventionally used for lithium secondary batteries, is used as a binder, a problem occurs that the electrode may peel off or the slurry may be gelled because PVDF is inferior in adhesion and alkali resistance. This is not only the case with the pure olivine Mn. It is also the same as the olivine-type lithium phosphates containing Mn (hereinafter, referred to as the olivine Mn based positive-electrode active material). As a result, the obtained electrode is not excellent in rate characteristic (charge-discharge characteristic) and cycle life.

If a certain amount or more of Fe having high conductivity in the olivine-type structure is substituted, the characteristics can be brought closer to that of the olivine Fe. In this case, the conditions of the diameter being made small and the alkali amount at the synthesis can be brought closer to those of the olivine Fe, and therefore it can be considered that the aforementioned gelatinization and peel-off may hardly occur. However, because the amount of Mn becomes small, the energy density is decreased. On the other hand, if a certain amount or more of Mn is contained in the olivine-type structure, the small diameter and an excessive amount of Li are needed at the synthesis in order to exhibit sufficient characteristics, thereby causing the aforementioned problem. If the problem is solved, high energy density can be obtained because the content rate of Mn is high. The aforementioned circumstances are same in other substituting elements that are inferior to Fe in conductivity.

Japanese Patent Application Laid-Open Publication No. 2000-21407 proposes that, in a lithium nickel oxide that is a high pH active material, acrylic rubber particles are used as a binder in order to prevent gelatinization of the binder. However, because the olivine Mn based positive-electrode active material is used after the specific surface area thereof has been made higher than that of the lithium nickel oxide, the binder is required to be excellent in adhesion as well as alkali resistance.

Lithium secondary batteries that use an excellent binder in its adhesion for the olivine based positive electrode are disclosed in, for example, Japanese Patent Application Laid-Open Publications Nos. 2005-251554 and 2007-194202.

The technique disclosed in Japanese Patent Application Laid-Open Publication No. 2005-251554 intends to improve rate characteristic and cycle life by strengthening the conductive network among the active material, the conductive additive, and the current collector, even when the diameter of the active material is made large, i.e., the specific surface area thereof is made small. When the diameter is made large, the electrode has an advantage that the packaging density can be increased.

However, when the olivine Mn based positive-electrode active material that is inferior in conductivity is used, the electron conductivity and the ion conductivity in the active material are inferior, even if the conductive network between the active materials is strengthened, and hence sufficient characteristics cannot be obtained when the diameter is large. Accordingly, the diffusion length of electrons and ions is needed to be shortened by the diameter being made small and the specific surface area being made high; the contact area with the covered carbons and the conductive additive is needed to be increased at the same time.

In addition, when using a polyacrylonitrile monomer, which is used in Japanese Patent Application Laid-Open Publication No. 2005-251554, as the binder for an olivine Mn based positive-electrode active material, the positive-electrode composite becomes inferior in flexibility. Therefore, in the roll press process and the wound body production process of electrodes, crack may be created in the positive-electrode composite or desorption of the positive-electrode composite may occur.

In Japanese Patent Application Laid-Open Publication No. 2007-194202, a structure is disclosed in which olivine Fe (LiFePO₄) is used as the active material and an acrylonitrile-based copolymer is used as the binder in order to improve the cycle life when charged with a high voltage. Because the electron conductivity of LiFePO₄ is larger than that of the olivine Mn based positive-electrode active material, the necessity for the diameter of the active material being made small is relatively small. Further, because the stable pH of LiFePO₄ is lower than that of the olivine Mn based positive-electrode active material, deterioration of the adhesion and gelatinization of the binder due to the high specific surface area hardly occur. However, as previously stated, the olivine Fe has lower operating voltage of 3.4 V than the olivine Mn based positive-electrode active material has of 4.1 V, and also has lower energy density.

As stated above, the techniques disclosed in Japanese Patent Application Laid-Open Publications Nos. 2005-251554 and 2007-194202 cannot solve the problems and do not take advantage of the characteristics of the olivine Mn based positive-electrode active material: high energy density, high specific surface area, and high alkali.

As stated above, it is necessary to use an olivine Mn based positive-electrode active material having a high operating voltage of 4.1 V in order to obtain larger energy density in a lithium secondary battery. The olivine Mn based positive electrode has problems of peel-off of the electrode and gelatinization of the binder because of a high specific surface area and high alkali, and therefore it is important to select preferred binder.

A positive-electrode active material that does not contain Mn, such as LiFePO₄, or that contains a small amount of Mn has a smaller specific surface area and lower pH than an olivine Mn based positive-electrode active material. Therefore, gelatinization of the slurry, and hardening and peel-off of the positive-electrode composite do not occur. Accordingly, when an olivine-type lithium phosphate is used as the active material, fully excellent characteristics can be obtained even if PVDF is used as the binder as generally used. However, LiFePO₄ has small energy density because of its low potential.

An object of the present invention is to provide a positive electrode for lithium secondary batteries in which, by using an olivine Mn based positive-electrode active material and an optimal binder for the olivine Mn based positive-electrode active material, peel-off of the electrode and gelatinization of the slurry can be prevented, with large energy density, excellent in rate characteristic and cycle life. The present invention also provides a lithium secondary battery using the positive electrode according to the present invention.

### SUMMARY OF THE INVENTION

The positive electrode for lithium secondary batteries according to the present invention has the following characteristics.

A positive electrode for lithium secondary batteries includes a positive-electrode composite including at least a positive-electrode active material and a binder; and a positive-electrode current collector. The positive-electrode active material includes a lithium composite oxide having an olivine-type structure, which is represented by the formula LiMnₓM_{1-X}PO₄ (where 0.3≦x≦1 and M is one or more elements selected from the group consisting of Li, Fe, Ni, Co, Ti, Cu, Zn, Mg, and Zr) . The binder includes an acrylonitrile-based copolymer.

It is preferable that the ratio of the acrylonitrile-based copolymer in the positive-electrode composite is 5-15 mass percentage.

It is preferable that the acrylonitrile-based copolymer is a copolymer made from either acrylonitrile or methacrylonitrile and a monomer having an ester group represented by the formula CH₂═CR₁—CO—O—R₂ (where R₁ is H or CH₃, and R₂ is any alkyl group or alkyl chain with a functional group, such as carboxyl group and hydroxy group).

The lithium secondary battery according to the present invention has the following characteristics.

A lithium secondary battery includes a positive electrode; a negative electrode; a separator between the positive electrode and the negative electrode; and an electrolyte. The positive electrode is the aforementioned positive electrode for lithium secondary batteries.

According to the present invention, a positive electrode for lithium secondary batteries and a lithium secondary battery can be obtained, which have large energy density and are excellent in rate characteristic and cycle life.

### BRIEF DESCRIPTION OF THE DRAWING

FIG. 1 is a partial cross-sectional view of a lithium secondary battery according to an embodiment of the present invention.

### DETAILED DESCRIPTION OF THE INVENTION

In the present invention, a positive electrode for lithium secondary batteries, which is excellent in adhesion and flexibility, can be obtained by using an olivine Mn based positive-electrode active material as an active material and an acrylonitrile-based copolymer as a binder. Further, by using this positive electrode, a lithium secondary battery that has large energy density and is excellent in rate characteristic (charge-discharge characteristic) and cycle life can be obtained.

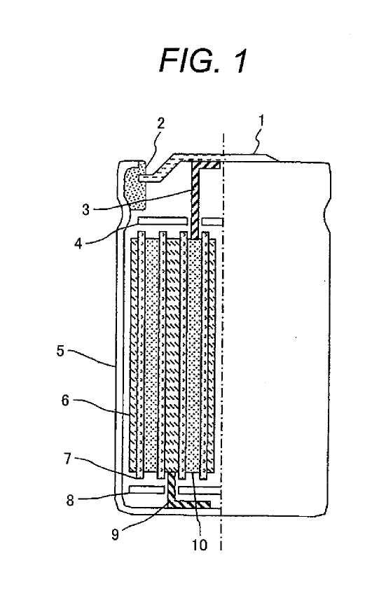

Hereinafter, the positive electrode for lithium secondary batteries and the lithium secondary battery according to the present invention will be described. FIG. 1 illustrates an example of the lithium secondary battery to which the positive electrode for lithium secondary batteries according to the invention is applied. A cylindrical lithium secondary battery is exemplified in FIG. 1. The lithium secondary battery includes a positive electrode (positive electrode for lithium secondary batteries according to the present invention) 10, a negative electrode 6, a separator 7, a positive electrode lead 3, a negative electrode lead 9, a battery cover 1, a gasket 2, an insulating plate 4, another insulating plate 8, and a battery can 5. The positive electrode 10 and the negative electrode 6 are wound with the separator 7 disposed between these electrodes. The separator 7 is impregnated with an electrolyte solution in which an electrolyte is dissolved in a solvent.

Hereinafter, the positive electrode 10, the negative electrode 6, the separator 7, and the electrolyte will be described in detail.

(1) Positive Electrode

The positive electrode for lithium secondary batteries according to the present invention includes a positive-electrode active material, a binder, and a current collector. A positive-electrode composite, which is composed of the positive-electrode active material and the binder, is formed on the current collector. A conductive additive may be added in the positive-electrode composite if needed in order to compensate the electron conductivity.

Hereinafter, the components of the positive electrode according to the present invention will be described in detail: the positive-electrode active material, the binder, the conductive additive, and the current collector.

### 1-A) Positive-Electrode Active Material

The positive electrode according to the present invention uses an olivine Mn based positive-electrode active material. In the invention, the olivine Mn based positive-electrode active material refers to a lithium composite oxide having an olivine structure, which is represented by LiMnₓM_{1-X}PO₄ (where 0.3≦x≦1 and M is one or more elements selected from the group consisting of Li, Fe, Ni, Co, Ti, Cu, Zn, Mg, and Zr) . In LiMnₓM_{1-X}PO₄, when M is an element that has an olivine-type structure even used alone, it is known that a charge-discharge curve has two steps and the capacity ratio thereof follows the composition ratio of Mn to the substituting element M.

If x is greater than or equal to 0.3, the theoretical average discharge voltage of this positive-electrode active material is greater than or equal to 3.6 V, even if M is Fe that has the lowest charge-discharge potential. That is, the positive-electrode active material has a higher discharge voltage than the average discharge voltage of the lithium cobalt oxide, which is the current mainstream, and therefore can be used as a positive-electrode active material that operates at a high voltage. A condition of X smaller than 0.3 and M being Fe is not desirable because the characteristic as a high potential positive electrode is lost. In addition, when x is greater than or equal to 0.3, the electron conductivity and the ion conductivity are inferior due to the influence from Mn. Therefore the active material is needed to have a high specific surface area and to be synthesized with an excessive amount of Li.

It is desirable that the olivine Mn based positive-electrode active material is used as a composite with carbon because a disadvantage of the electron conductivity can be compensated. Further, in order to improve the electron conductivity and the ion conductivity, it is desirable that the specific surface area of the positive-electrode active material is greater than or equal to 15 m²/g. When the specific surface area is smaller than 15 m²/g, the sufficient electron conductivity and ion conductivity cannot be obtained in active materials having x greater than or equal to 0.3, thereby deteriorating the performance. When the specific surface area is too large, a smooth electrode cannot be obtained because aggregates are created during the production of the electrode, and the energy density is decreased because the packaging density of the electrode is decreased. Therefore, it is desirable that the specific surface area of the positive-electrode active material is smaller than or equal to 100 m²/g.

If polyvinylidene fluoride (PVDF) is used as a binder for such an olivine Mn based positive-electrode active material, the gelatinization of the slurry and the hardening of the positive-electrode composite layer may occur because PVDF is inferior in alkali resistance in addition to its original inferiority in adhesion, as stated above. Then, the adhesion and the flexibility of the electrode are deteriorated, causing peel-off. Accordingly, the obtained electrode is not excellent in rate characteristic and cycle life. Therefore, the following binder is used in the present invention.

### 1-B) Binder

It is necessary for the olivine Mn based positive-electrode active material to be used after its specific surface area has been made high. Further, because it is desirable that the olivine Mn based positive-electrode active material is synthesized with an excessive amount of Li, the active material is likely to be high alkali. The inventors have newly found that, in order to sufficiently take advantage of the characteristics of such an active material, it is needed that the binder satisfies the three characteristics at the same time: high adhesion, alkali resistance, and flexibility. Hereinafter, such binder will be described in detail.

### 1-B-1) High Adhesion

When the specific surface area of an active material is made high, the amount of the binder, which is necessary for the bonding between the active materials, is increased; therefore the adhesion between the active materials becomes inferior if the same amount of the binder is used as an amount for an active material with a normal specific surface area. Even if the bonding between the active materials is maintained by increasing the amount of the binder, a large amount of the binder is adsorbed between the active materials, and then a problem arises of the peel-off between the active material layer and the current collector, which are originally hetero phases to each other and inferior in the adhesion. If a large amount of the binder is further used in order to maintain the adhesion between the active material and the current collector, the binder covers the surface of the active material. Accordingly, the diffusion of Li ions is hampered and the characteristics of the active material are decreased in spite of the high specific surface area. With the decrease in the characteristics thereof, the energy density of the electrode is also decreased.

That is, an active material having a high specific surface area needs a binder that has strong bonding force so that, even when used in a small amount, the adhesion between the active materials and that between the active material and the current collector can be maintained.

### 1-B-2) Alkali Resistance

It is pointed out that, if an electrode is made by using a high alkali active material and polyvinylidene fluoride (PVDF), which is generally used as a binder at present, cross-linking reactions occur within the molecules or between the molecules of PVDF by reacting with the alkali in the active material. When lithium nickel oxide, which has a rock-salt structure and is known as a high alkali active material, is used for an active material, a drawback occurs that the electrode which the active material has been applied to may be hardened, or that the stored slurry may be gelled. Further, when an olivine Mn, which has a remarkably higher specific surface area than lithium nickel oxide, is used as a positive-electrode active material, it is difficult to uniformly apply the olivine Mn onto the electrode sheet because the mixture of the active material and PVDF is gelled immediately due to the large reaction area and accordingly the large reaction rate of the olivine Mn.

From these reasons, it is essential to use a binder that is excellent in alkali resistance.

### 1-B-3) Flexibility

Taking into consideration the actual battery production process, the binder is needed to have high flexibility in addition to the aforementioned two characteristics. If the binder is deficient in flexibility, the problem may occur that, in the roll press process or the winding process, crack is created in the positive-electrode composite layer or peel-off arises between the current collector and the positive-electrode composite layer. In particular, because the olivine Mn based positive-electrode active material has a high specific surface area, its packaging density is low as powder. Accordingly, it is necessary that, when made into a battery, the film thickness is made large in order to obtain a sufficient capacity. When a thick composite layer is wound, the stress difference within the composite layer or between the composite layer and the current collector becomes large, the crack or the peel-off is more likely to occur. In the electrode in which the crack has occurred, the conductive network thereof may collapse and desorption from the current collector may occur, deteriorating the performance of the electrode.

Accordingly, the binder having high flexibility is essential in the olivine Mn based positive-electrode active material.

In addition, swelling property and liquid-holding property are associated characteristics with the adhesion.

If the binder has too high swelling property, the contacts between the active materials and between the active material and the conductive additive become loose because the binder swells due to the electrolyte, deteriorating the conductivity of the electrode composite. In contrast, if the binder has too low swelling property, i.e., the binder is inferior in liquid-holding property, the electrolyte and the lithium salt around the active material become lacking, deteriorating the characteristics. The balance between the aforementioned two factors is important for the swelling property, and hence PVDF has been preferably used as the binder in the active materials having a rock-salt structure, such as lithium cobalt oxide.

However, the olivine Mn based positive-electrode active material in the present invention has a remarkably larger specific surface area than lithium cobalt oxide. Accordingly, the active material needs a larger amount of binder than lithium cobalt oxide. Therefore, if PVDF is used as the binder, the electrode composite may be strongly influenced by the contact deterioration and the desorption due to the swelling property. When using the binder with low swelling property, in the case of the olivine Mn based positive-electrode active material, sufficient electrolyte can be held around the active material and the electrolyte does not become lacking with charge/discharge process because of the large specific surface area and low density of the active material, although, in the case of lithium cobalt oxide, the electrode composite may be influenced by the low liquid-holding property.

From the aforementioned reasons, the binder having low swelling property is desirable for the active material having a high specific surface area.

As stated above, the olivine Mn based positive-electrode active material needs a binder which satisfies the aforementioned three properties at the same time: the high adhesion, the alkali resistance, and the flexibility. As the binder that satisfies this condition and takes sufficient advantage of the characteristics of the olivine Mn based positive-electrode active material, an acrylonitrile-based copolymer has been found in the present invention. The acrylonitrile-based copolymer is made by copolymerizing a monomer having a nitrile group with other monomers, such as acrylate, methacrylate, styrene derivative, vinyl derivative, and carboxylic acid. When an acrylonitrile-based copolymer is used as the binder in the olivine Mn based positive-electrode active material, the positive-electrode active material has significant effects in comparison with the case where the conventional binder is used, as described in detail in the following Examples and Comparative Examples.

The binder obtained by polymerizing a monomer having a nitrile group, such as acrylonitrile, is excellent in its adhesion; however, the positive-electrode composite layer is inferior in flexibility because the binder is a rigid polymer, thereby causing the aforementioned problem of the crack and the peel-off. Accordingly, the conductive network of the electrode collapses due to the crack occurred in the electrode, which entails the decreased rate characteristic. In addition, the peel-off expands with charge/discharge process, adversely affecting the cycle life.

However, such problem can be solved by copolymerizing a monomer having a nitrile group with the aforementioned other monomers to provide flexibility.

Examples of the acrylate include alkyl acrylate, such as methyl acrylate and lauryl acrylate; hydroxy acrylic acrylate, such as 2-hydroxyethyl acrylate and 2-hydroxypropyl acrylate; and amino alkyl acrylate, such as amino methyl acrylate and N,N-dimethylaminoethyl acrylate.

Examples of the methacrylate include alkyl methacrylate, such as methyl methacrylate and lauryl methacrylate; hydroxy acrylic methacrylate, such as 2-hydroxyethyl methacrylate and 2-hydroxypropyl methacrylate; and aminoalkyl methacrylate, such as aminomethyl methacrylate and N,N-dimethylaminoethyl methacrylate.

Examples of the styrene derivatives include styrene vinyl toluene and α-methylstyrene.

Examples of the vinyl derivatives include vinyl acetate and vinyl chloride.

Examples of the carboxylic acid include acrylic acid and methacrylic acid.

To improve the adhesion, it is desirable that the monomer having a nitrile group is acrylic nitrile or methacrylic nitrile. To improve the flexibility, it is particularly desirable that the copolymerization component with the monomer having a nitrile group is the monomer containing an ester group represented by Formula 1:

CH₂═CR₁—CO—O—R₂ (1)

where R₁ is H or CH₃, and R₂ is any alkyl group or alkyl chain with a functional group, such as carboxyl group and hydroxy group.

In order to sufficiently maintain the bonding between the current collector and the active material and that between the active material and the conductive additive, it is desirable that the amount of an acrylonitrile-based copolymer, which is the binder, is greater than or equal to 5 mass percentage. In the electrode in which the binder amount is within the range of 5 mass percentage to 15 mass percentage (both inclusive), each of the rate characteristic and the cycle life exhibits excellent characteristic because the binder amount is appropriate.

When the binder amount is smaller than the aforementioned range, the adhesion of the electrode is inferior due to the deficiency of the binder, and hence the conductivity of the electrode is insufficient, impairing the rate characteristic. Also, because floating up or desorption of the positive-electrode composite occurs with charge/discharge process, the cycle life is deteriorated. In contrast, when the binder amount is larger than the aforementioned range, the cycle life is not deteriorated because of the sufficient adhesion; however, the rate characteristic is deteriorated because the binder may cover the surface of the active material and the ratio of the non-conductive substances in the positive-electrode composite is increased due to the excessive amount of the binder.

### 1-C) Conductive Additive

When conductive additive is mixed into the structure of the positive electrode in order to provide conductivity as well as the use of the binder that is excellent in adhesion as stated above, a strong conductive network can be formed. Accordingly, the conductivity of the positive electrode is improved and the capacity and the rate characteristic thereof can be desirably improved. Hereinafter, the conductive additive to be used in the positive electrode according to the present invention and the amount thereof will be described.

As the conductive additive, carbon based conductive additives, such as acetylene black and graphite powder, can be used. Because the olivine Mn based positive-electrode active material has a high specific surface area, it is desirable that the conductive additive has a high specific surface area in order to form a conductive network. Specifically, acetylene black is desired. When the positive-electrode active material is covered with carbon, the covering carbon can also be used as the conductive additive.

It is desirable that the amount of the conductive additive (when the positive-electrode active material is covered with carbon, the total amount of the covering carbon and the conductive additive to be added) is 5 mass percentage to 10 mass percentage (both inclusive) of the positive-electrode composite. If the amount thereof is smaller than 5 mass percentage, the conductivity between the active materials and that between the active material and the current collector cannot be sufficiently maintained. If the amount thereof is larger than 10 mass percentage, the energy density of the electrode is decreased.

### 1-D) Current Collector

As the current collector, a conductive support, such as aluminum foil, can be used.

As stated above, in order to obtain a positive electrode that has a high potential and excellent rate characteristic and cycle life, it is desirable that an olivine Mn based positive-electrode active material is used as the positive-electrode active material, an acrylonitrile copolymer is used as the binder, and conductive additive (when the positive-electrode active material is covered with carbon, the covering carbon on the active material is also included) is used.

### (2) Negative Electrode

The negative electrode of the lithium secondary battery according to the present invention includes a negative-electrode active material, a conductive additive, a binder, and a current collector.

As the negative-electrode active material, any material may be used that can reversibly perform insertion and desorption of Li with charge/discharge process. Examples of such materials include a carbon material, a metal oxide, a metal sulfide, a lithium metal, and an alloy of a lithium metal and other metal. As the carbon material, graphite, amorphous carbon, coke, pyrolytic carbon can be used.

As the conductive additive, any additive can be used that has been conventionally known, including carbon based conductive additive, such as acetylene black and graphite powder. As the binder, any can be used that has been conventionally known, including PVDF (polyvinylidene fluoride), SBR (styrene-butadiene rubber), and NBR (nitrile rubber). As the current collector, any can be used that has been conventionally known, including a conductive support, such as copper foil.

### (3) Separator

As the separator, a material that has been conventionally known can be used, without any limitation. For example, a polyolefin based porous membrane, such as polypropylene and polyethylene, and a glass fiber sheet can be used.

### (4) Electrolyte

As the electrolyte, a lithium salt, such as LiPF₆, LiBF₄, LiCF₃SO₃, LiN SO₂CF₃)₂, and LiN(SO₂F)₂, can be used alone or in combination thereof. Examples of solvents for dissolving the lithium salt include a chain carbonate, a cyclic carbonate, a cyclic ester, a nitrile compound. Specifically, ethylene carbonate, propylene carbonate, diethyl carbonate, dimethoxyethane, γ-butyrolactone, n-methyl pyrrolidine, and acetonitrile can be cited.

Other than those, a polymer gel electrolyte and a solid electrolyte can also be used as the electrolyte.

Various forms of lithium secondary batteries can be structured, such as a cylindrical battery, a square battery, and a laminated battery, by using the aforementioned positive electrode, negative electrode, separator, and electrolyte.

The positive electrode for lithium secondary batteries according to the present invention will be described in detail in the following Examples. In the following Examples, M of the olivine Mn based positive-electrode active material LiMnₓM₁₋ₓPO₄ is set to be Fe. Besides this, M may be an element selected from the group consisting of Li, Ni, Co, Ti, Cu, Zn, Mg, and Zr, or two or more elements selected from the group consisting of Li, Fe, Ni, Co, Ti, Cu, Zn, Mg, and Zr. With these elements, similar effects as the case where M is set to be Fe can be obtained, except for the inferior conductivity.

The present invention is not limited to these Examples. Various modifications can be made without departing from the gist of the invention.

### EXAMPLE 1

### <Production of Electrode Sheet for Positive Electrode>

At first, LiMn₀₈Fe_{0.2}PO₄, which is an olivine Mn based positive-electrode active material, was synthesized in the following manner.

14. 4 g of NH₄H₂PO₄ and 5.55 g of LiOH.H₂O, 17.9 g of MnC₂O₄.2H₂O, and 4.50 g of FeC₂O₄.2H₂O were mixed, and to which dextrin was added so as to be contained in 12 mass percentage. Thereafter, zirconia grinding balls were placed in a zirconia pot so that the aforementioned mixture was mixed by using a planetary ball mill. This mixed powder was fed into an aluminum crucible, and then subjected to preliminary firing at 400° C. for 10 hours under flowing argon at 0.3 L/min. The obtained preliminarily fired body was once crushed in a sardonyx mortar and again fed into the aluminum crucible to be subjected to glost firing at 700° C. for 10 hours under flowing argon at 0.3 L/min. After the glost firing, the obtained powder was crushed in the sardonyx mortal and then subjected to grain size control by using a 45-μm mesh screen to obtain the material represented by the composition formula LiMn_{0.8}Fe_{0.2}PO₄.

The obtained material was subjected to the X-ray diffraction analysis using the RINT 2000 made by Rigaku Corporation to confirm that the material belongs to an olivine-type structure (space group Pmna). In this way, LiMn_{0.8}Fe_{0.2}PO₄, which is an olivine Mn based positive-electrode active material, was obtained.

Subsequently, the positive-electrode active material was weighed and then a conductive additive and a binder were added to so that the mass ratio of the active material, the conductive additive, and the binder was 83:9.5:7.5, thereby producing a positive-electrode composite. That is, the ratio of the binder in the positive-electrode composite is 7.5 mass percentage. The mass of the active material was determined to be that of the active material itself, excluding the covering carbon. The mass of the conductive additive was determined to be the total mass of the covering carbon of the active material and the acetylene black that was newly added. As the binder, an acrylonitrile-based copolymer was used that was made by copolymerizing acrylonitrile with lauryl acrylate at a mass ratio of 9:1 and was dispersed in N-methyl-2-pyrrolidone (NMP).

N-methyl-2-pyrrolidone was added to the positive-electrode composite as a dispersant in order to control the viscosity, and then by stirring the positive-electrode composite with a rotating and revolving mixer, the slurry for positive electrode was obtained. As a result of observing the state of the obtained slurry, the slurry was in a good condition without gelatinization.

This slurry was applied onto an aluminum current collector having a thickness of 20 μm by using a coating blade with a 250-μm gap. The aluminum current collector was preliminarily dried at 80° C., and then dried at 120° C. under reduced pressure to obtain an electrode sheet for the positive electrode.

### <Evaluation of Powder Properties of Material>

In order to evaluate powder properties of the synthesized material, the following pH measurement and the specific surface area measurement for the active material were performed.

### <<pH Measurement for Active Material>>

One gram of the produced positive-electrode active material and 50 g of purified water were weighed under an atmosphere of 25° C., and then were mixed in a glass beaker and stirred for one minute. Thereafter, the beaker was covered over the mouth with a transparent film and left at rest for 60 minutes in a sealed state. And then, the pH of the supernatant solution was measured according to JIS (Japanese Industrial Standard) Z 8802 and JIS Z 8805.

### <<Specific Surface Area Measurement for Active Material>>

The specific surface area of the active material can be measured by using a publicly known BET specific surface area measuring apparatus for powder. In the present Examples, the specific surface area of the active material was measured by using the specific surface area measuring apparatus BELSORP mini made by BEL Japan, Inc. N₂ was used as an adsorption gas and the measurement was performed at the liquid nitrogen temperature.

### <Evaluation of Mechanical Properties and Electrochemical Properties of Electrode>

In order to evaluate the mechanical properties and the electrochemical properties of the produced electrode sheet for the positive electrode, a flexibility measurement (a bending test), a peel-off test, a rate test, and a cycle test were performed.

### <<Flexibility Measurement (Bending Test)>>

A test specimen of 10×3 cm was cut off from the produced electrode sheet so that the bending test was performed according to the testing method specified in JIS K 5600-5-1. From the measurement of the thickness of the electrodes, it was found that all electrodes had a thickness of 40 to 50 μm, which was an appropriate film thickness for the test using the type I apparatus specified in JIS K 5600-5-1. Tests were performed from 10 mm to 2 mm of the mandrel diameter at intervals of 1 mm, and the diameter at which crack had occurred for the first time was recorded. As the mandrel diameter is larger, the electrode lacks the flexibility.

### <<Peel-off Test>>

A test specimen of 10×5 cm was cut off from the produced electrode sheet so that the peel-off test was performed according to the testing method specified in JIS K 5600-5-6. From the measurement of the thickness of the electrodes, it was found that all electrodes had a film thickness of smaller than or equal to 60 μm. The electrodes were cross-cut at intervals of 2 mm. A tape with a width of 25 mm was attached to the electrode in a lattice pattern and the peel-off appearance was observed when the tape was peeled off. The peel-off appearance was evaluated according to the evaluation standard and recorded. The evaluation standard was the six-step evaluation specified in JIS K 5600-5-6, in which the smallest peel-off is evaluated as 0 and the largest one is evaluated as 5.

### <<Rate Test>>

The rate test was performed by using a model cell. A disk-shaped specimen with a diameter of 15 mm, which was punched out from the produced electrode sheet, was used as the positive electrode of the model cell. Lithium metals were arranged as the counter electrode and the reference electrode. A polypropylene-polyethylene laminated separator with a thickness of 30 μm was used as the separator. The electrolyte used in the test was made with LiPF₆ dissolved in the solvent, which was made by mixing ethylene carbonate (EC) and ethyl methyl carbonate (EMC) at a ratio of 2:1 so that the concentration thereof became 1M.

For the model cell, the reference discharge capacity was defined as the discharge capacity obtained when the model cell was charged/discharged with a current of 0.05 mA/cm² and a voltage within a range of 3 V to 4.3 V. In the rate test, the specific capacity (%) was calculated by dividing the discharge capacity, which was obtained when the model cell was charged with a current of 0.05 mA/cm² and then discharged with a current of 5 mA/cm², by the reference discharge capacity. The rate characteristic (charge/discharge characteristic) is excellent as the specific capacity is larger.

### <<Cycle Test>>

A model cell used in the cycle test was the same as that used in the aforementioned rate test in terms of the structure, the electrolyte, and the voltage range of the reference discharge capacity.

The model cell was evaluated by performing 100 cycles of charge/discharge operations with a current of 0.25 mA/cm² after initializing the model cell with the same current value. Assuming that the discharge capacity at the first cycle was 100%, the specific capacity (%) was determined from the discharge capacity at the 100th cycle. The cycle life was evaluated by the specific capacity. The model cell is excellent in cycle life and has a longer life as the specific capacity is larger.

Hereinafter, evaluation results of the positive electrode in Example 1 will be summarized.

It was found that pH of the active material was 11.1 from the result of the pH measurement and the specific surface area thereof was 39 m²/g from the result of the specific surface area measurement . The active material has a higher pH and a higher specific surface area than the lithium cobalt oxide that is currently the mainstream.

The electrode had no crack in the flexibility measurement (bending test) and was evaluated as 0 in the peel-off test. From the aforementioned results, it was found that the positive electrode in Example 1 was excellent in flexibility and adhesion. Accordingly, the rate test result using the electrode was as good as 69%; the cycle life was also excellent showing 99% or more of the capacity maintenance ratio after 100 cycle operations in the cycle test.

Table 1 shows the compositions of the active materials, the binders, and the binder amounts. Table 2 shows the pH and the specific surface areas of the active materials. Table 3 shows the slurry states, the results of the flexibility measurements (bending tests), and the results of the peel-off test. Table 4 shows the results of the rate test and the cycle test. In the results of the flexibility measurement (bending test) in Table 3, the electrode in which crack did not occur even for 2 mm of the mandrel diameter was recorded with ◯.

Subsequently, positive electrodes were produced with active materials other than that used in Example 1 of the olivine Mn based positive-electrode active materials, using the acrylonitrile-based copolymer as the binder, and the electrode characteristics were evaluated. These results were shown in Examples 2 and 3, and were listed in Tables 1 through 4.

### EXAMPLE 2

In Example 2, the composition of the active material was changed to LiMn_{0.3}Fe_{0.7}PO₄. Production of the electrode sheet for the positive electrode, evaluation of powder properties of the material, and evaluation of mechanical properties and electrochemical properties of the electrode were performed in the same way as in Example 1 except that LiMn_{0.3}Fe_{0.7}PO₄ was synthesized by mixing 14.4 g of NH₄H₂PO₄, 5.37 g of LiOH.H₂O, 6.71 g of MnC₂O₄.2H₂O and 15.7 g of FeC₂O₄.2H₂O.

It was found that pH of the active material was 11.01 from the result of the pH measurement and the specific surface area thereof was 35 m²/g from the result of the specific surface area measurement.

Gelatinization of the slurry prior to the application was not observed and the state thereof was excellent. The electrode had no crack in the flexibility measurement (bending test) and was evaluated as 0 in the peel-off test. The rate test result was 80% and the capacity maintenance ratio after 100 cycle operations in the cycle test was greater than or equal to 99%.

From the aforementioned results, it can be found that the obtained electrode is excellent in flexibility, adhesion, rate characteristic, and cycle characteristic.

### EXAMPLE 3

In Example 3, the composition of the active material was changed to LiMnPO₄. Production of the electrode sheet for the positive electrode, evaluation of powder properties of the material, and evaluation of mechanical properties and electrochemical properties of the electrode were performed in the same way as in Example 1 except that LiMnPO₄ was synthesized by mixing 14.4 g of NH₄H₂PO₄, 5.67 g of LiOH.H₂O, and 22.4 g of MnC₂O₄.2H₂O .

It was found that pH of the active material was 11.2 from the result of the pH measurement and the specific surface area thereof was 42 m²/g from the result of the specific surface area measurement.

Gelatinization of the slurry prior to the application was not observed and the state thereof was excellent. The electrode had no crack in the flexibility measurement (bending test) and was evaluated as 0 in the peel-off test. The rate test result was 48% and the capacity maintenance ratio after 100 cycle operations in the cycle test was greater than or equal to 99%.

From the aforementioned results, it can be found that the obtained electrode is excellent in flexibility, adhesion, and cycle characteristic and has a relatively high rate characteristic.

As illustrated above, the electrodes excellent in flexibility and adhesion were obtained even in Examples 2 and 3, each of which exhibited the superior rate characteristic and cycle life. When Examples 1 to 3 are compared, the rate characteristic is improved in the ascending order of Fe content (in the order of Example 3, Example 1, and Example 2) This is because the conductivity is improved by substituting Fe for Mn.

However, it is desirable that the maximum content of Fe is up to the ratio of Mn to Fe of 3:7 because the energy density is decreased as the content of Fe becomes larger. That is, when the composition of the active material is represented by LiMnₓFe_{1-X}PO₄, it is desirable that x is greater than or equal to 0.3. When x is greater than or equal to 0.3, a higher voltage is obtained compared to a battery in which the conventional active material (for example, LiCoO₂) is used, taking advantage of the characteristic of the olivine Mn based positive-electrode active material having large energy density.

Subsequently, electrodes were produced with the active materials evaluated in Examples 1 to 3, using polyvinylidene fluoride (PVDF) as the binder, and the electrode characteristics were evaluated by performing the aforementioned measurements and tests. These results were represented as Comparative Examples 1 to 3, and were discussed in comparison with Examples 1 to 3 to be listed in Tables 1, 3, and 4.

### COMPARATIVE EXAMPLE 1

Production of the electrode sheet for the positive electrode and evaluation of mechanical properties and electrochemical properties of the electrode were performed in the same way as in Example 1 except that PVDF was used as the binder.

In this case, gelatinization of the slurry was observed at the production of the slurry. The mandrel diameter was 7 mm when crack had occurred in the flexibility measurement (bending test). The electrode was evaluated as 5 in the peel-off test. From these results, it was shown that the electrode was remarkably poor in flexibility and adhesion.

The rate test result was 23% and the capacity maintenance ratio after 100 cycle operations in the cycle test was 65%, which were significantly inferior to those in Example 1 in which the same active material was used.

### COMPARATIVE EXAMPLE 2

Production of the electrode sheet for the positive electrode and evaluation of mechanical properties and electrochemical properties of the electrode were performed in the same way as in Example 2 except that PVDF was used as the binder.

Even in this case, gelatinization of the slurry was also observed at the production of the slurry. The mandrel diameter was 5 mm when crack had occurred in the flexibility measurement (bending test) . The electrode was evaluated as 5 in the peel-off test. From these results, it was shown that the electrode was remarkably poor in flexibility and adhesion.

The rate test result was 35% and the capacity maintenance ratio after 100 cycle operations in the cycle test was 68%, which were significantly inferior to those in Example 2 in which the same active material was used.

### COMPARATIVE EXAMPLE 3

Production of the electrode sheet for the positive electrode and evaluation of mechanical properties and electrochemical properties of the electrode were performed in the same way as in Example 3 except that PVDF was used as the binder.

Even in this case, gelatinization of the slurry was also observed at the production of the slurry. The mandrel diameter was 8 mm when crack had occurred in the flexibility measurement (bending test) . The electrode was evaluated as 5 in the peel-off test. From these results, it was shown that the electrode was remarkably poor in flexibility and adhesion.

The rate test result was 15% and the capacity maintenance ratio after 100 cycle operations in the cycle test was 51%, which were significantly inferior to those in Example 3 in which the same active material was used.

The results of the aforementioned Examples 1 to 3 and Comparative Examples 1 to 3 lead to the following conclusion with respect to the olivine Mn based positive-electrode active material. When Examples 1 to 3 in which the acrylonitrile-based copolymer was used as the binder was compared to Comparative Examples 1 to 3 in which PVDF was used as the binder, the electrodes in which the acrylonitrile-based copolymer was used as the binder were superior in all matters of the flexibility, the adhesion, the rate characteristic, and the cycle life, for any composition of the olivine Mn based positive-electrode active material. The electrode including PVDF, which has poor adhesion and alkali resistance, is inferior in rate characteristic and cycle life because of the poor adhesion and flexibility and occurrence of the peel-off.

Subsequently, as Comparative Example 4, an electrode was produced and evaluated, in which the olivine Mn based positive-electrode active material was used as the active material and a polyacrylonitrile monomer was used as the binder. The results were compared with those in Example 1 (the active material was an olivine-Mn based positive-electrode active material and the binder was an acrylonitrile copolymer) to be listed in Tables 1, 3 and 4.

### COMPARATIVE EXAMPLE 4

Production of the electrode sheet for the positive electrode and evaluation of mechanical properties and electrochemical properties of the electrode were performed in the same way as in Example 1 except that a polyacrylonitrile monomer was used as the binder.

Gelatinization of the slurry prior to application was not observed and the state thereof was excellent. The mandrel diameter was 5 mm when crack had occurred in the flexibility measurement (bending test). The electrode was evaluated as 1 in the peel-off test. The rate test result was 45% and the capacity maintenance ratio after 100 cycle operations in the cycle test was 88%.

From the aforementioned results, it has been found that the electrode in Comparative Example 4, comparing with the case of Example 1, had almost the same adhesion but was inferior in flexibility. Further, the electrode therein was significantly inferior in the rate test result and also slightly inferior in the cycle test result.

From the results of Comparative Example 4, Example 1, and Comparative Example 1, it can be learned that the positive electrodes have different characteristics and properties from each other depending on the binders even when using the same composition of olivine-Mn based positive-electrode active materials.

In the electrode in which a polyacrylonitrile monomer is used as the binder (Comparative Example 4), the gelatinization of the slurry can be prevented and the adhesion is improved in comparison with the electrode including PVDF (Comparative Example 1). However, it can be learned that, comparing with the electrode including the acrylonitrile-based copolymer (Example 1), the electrode is inferior in flexibility, rate characteristic, and cycle life. The reason is considered as follows: because of occurrence of the crack and collapse of the conductive network in the electrode, the rate characteristic of the electrode is decreased, and the peeing-off has expanded with charge/discharge process.

Subsequently, as Examples 4 and 5 and Comparative Examples 5 and 6, in the same electrode structure as in Example 1 in which an olivine Mn based positive-electrode active material is used as the active material and an acrylonitrile copolymer is used as the binder, electrodes were produced by increasing/decreasing the amount of the binder in Example 1. The produced electrodes were evaluated and listed in Tables 1, 3 and 4. From these results, a preferred range of the binder amount was determined in the case where an acrylonitrile copolymer was used as the binder.

### EXAMPLE 4

Production of an electrode sheet for the positive electrode and evaluation of mechanical properties and electrochemical properties of the electrode were performed in the same way as in Example 1 except that the positive-electrode active material, the conductive additive, and the binder were weighed so that the mass ratio thereof was 85.5:9.5:5 and then mixed to produce a positive-electrode composite. That is, the ratio of the binder in the positive-electrode composite is 5 mass percentage.

In this case, gelatinization of the slurry prior to application was not observed and the state thereof was excellent. The electrode had no crack in the flexibility measurement (bending test) and was evaluated as 0 in the peel-off test. The rate test result was 65% and the capacity maintenance ratio after 100 cycle operations in the cycle test was greater than or equal to 99%. These results were almost the same as in Example 1, exhibiting superior characteristics.

### EXAMPLE 5

Production of an electrode sheet for the positive electrode and evaluation of mechanical properties and electrochemical properties of the electrode were performed in the same way as in Example 1 except that the positive-electrode active material, the conductive additive, and the binder were weighed so that the mass ratio thereof was 75.5:9.5:15 and then mixed to produce a positive-electrode composite. That is, the ratio of the binder in the positive-electrode composite is 15 mass percentage.

Also in this case, gelatinization of the slurry prior to application was not observed and the state thereof was excellent. The electrode had no crack in the flexibility measurement (bending test) and was evaluated as 0 in the peel-off test . The rate test result was 69% and the capacity maintenance ratio after 100 cycle operations in the cycle test was greater than or equal to 99%. These results were the same as in Example 1, exhibiting superior characteristics.

### COMPARATIVE EXAMPLE 5

Production of an electrode sheet for the positive electrode and evaluation of mechanical properties and electrochemical properties of the electrode were performed in the same way as in Example 1 except that the positive-electrode active material, the conductive additive, and the binder were weighed so that the mass ratio thereof was 88.5:9.5:2 and then mixed to produce a positive-electrode composite. That is, the ratio of the binder in the positive-electrode composite is 2 mass percentage.

In this case, gelatinization of the slurry prior to application was not observed; the state thereof was excellent; and the electrode had no crack in the flexibility measurement (bending test). However, the electrode was evaluated as 4 in the peel-off test. The rate test result was 46% and the capacity maintenance ratio after 100 cycle operations in the cycle test was 71%. Comparing with the results in Example 1, the electrode was significantly inferior in adhesion, and, as a result, inferior in rate characteristic and cycle life.

### COMPARATIVE EXAMPLE 6

Production of an electrode sheet for the positive electrode and evaluation of mechanical properties and electrochemical properties of the electrode were performed in the same way as in Example 1 except that the positive-electrode active material, the conductive additive, and the binder were weighed so that the mass ratio thereof was 70.5:9.5:20 and then mixed to produce a positive-electrode composite. That is, the ratio of the binder in the positive-electrode composite is 20 mass percentage.

In this case, gelatinization of the slurry prior to application was not observed and the state thereof was excellent. The electrode had no crack in the flexibility measurement (bending test) and the electrode was evaluated as 0 in the peel-off test. The rate test result was 21% and the capacity maintenance ratio after 100 cycle operations in the cycle test was greater than or equal to 99%. Comparing with the results in Example 1, the electrode had the same adhesion and cycle life, but had a significantly inferior rate characteristic.

From the results of Examples 1, 4, and 5, and Comparative Examples 5 and 6, the electrodes that include the binder in the range of 5 mass percentage to 15 mass percentage are excellent in both the rate characteristic and the cycle life because the amounts of the binder are appropriate. The electrodes in Examples 4 and 5, each of which had a binder amount in the aforementioned range, exhibited excellent rate characteristic and cycle life in the same way as in Example 1.

In Comparative Example 5, where the binder amount is smaller than the aforementioned range, the conductivity of the electrode is insufficient and the rate characteristic is not excellent because the binder is deficient and therefore the electrode is inferior in adhesion. Further, the cycle life was deteriorated because floating up or desorption of the positive-electrode composite occurred with charge/discharge process.

In Comparative Example 6, where the binder amount is larger than the aforementioned range, the cycle life of the electrode was excellent in the same way as in Examples 1, 4, and 5 because the adhesion was sufficient. However, the rate characteristic was deteriorated because the binder amount was excessive, resulting in covering the surface of the active material or increasing the ratio of the non-conductive substance in the positive-electrode composite.

TABLE 1

| | | | Binder Amount |
|---|---|---|---|
| | | | (mass |
| | Active Material | Binder | percentage) |
| Example 1 | LiMn_{0.8}Fe_{0.2}PO₄ | acrylonitrile-based | 7.5 |
| | | copolymer | |
| Example 2 | LiMn_{0.3}Fe_{0.7}PO₄ | acrylonitrile-based | 7.5 |
| | | copolymer | |
| Example 3 | LiMnPO₄ | acrylonitrile-based | 7.5 |
| | | copolymer | |
| Example 4 | LiMn_{0.8}Fe_{0.2}PO₄ | acrylonitrile-based | 5 |
| | | copolymer | |
| Example 5 | LiMn_{0.8}Fe_{0.2}PO₄ | acrylonitrile-based | 15 |
| | | copolymer | |
| Comparative | LiMn_{0.8}Fe_{0.2}PO₄ | PVDF | 7.5 |
| Example 1 | | | |
| Comparative | LiMn_{0.3}Fe_{0.7}PO₄ | PVDF | 7.5 |
| Example 2 | | | |
| Comparative | LiMnPO₄ | PVDF | 7.5 |
| Example 3 | | | |
| Comparative | LiMn_{0.8}Fe_{0.2}PO₄ | polyacrylonitrile | 7.5 |
| Example 4 | | monomer | |
| Comparative | LiMn_{0.8}Fe_{0.2}PO₄ | acrylonitrile-based | 2 |
| Example 5 | | copolymer | |
| Comparative | LiMn_{0.8}Fe_{0.2}PO₄ | acrylonitrile-based | 20 |
| Example 6 | | copolymer | |

TABLE 2

| | | | Specific Surface |
|---|---|---|---|
| | Active Material | pH | Area (m²/g) |
| Example 1 | LiMn_{0.8}Fe_{0.2}PO₄ | 11.1 | 39 |
| Example 2 | LiMn_{0.3}Fe_{0.7}PO₄ | 11.01 | 35 |
| Example 3 | LiMnPO₄ | 11.2 | 42 |

TABLE 3

| | | Flexibility Measurement | Peel-off |
|---|---|---|---|
| | Slurry State | (mandrel diameter/mm) | Test |
| Example 1 | Excellent | ◯ | 0 |
| Example 2 | Excellent | ◯ | 0 |
| Example 3 | Excellent | ◯ | 0 |
| Example 4 | Excellent | ◯ | 0 |
| Example 5 | Excellent | ◯ | 0 |
| Comparative | Gelatinization | 7 | 5 |
| Example 1 | | | |
| Comparative | Gelatinization | 5 | 5 |
| Example 2 | | | |
| Comparative | Gelatinization | 8 | 5 |
| Example 3 | | | |
| Comparative | Excellent | 5 | 1 |
| Example 4 | | | |
| Comparative | Excellent | ◯ | 4 |
| Example 5 | | | |
| Comparative | Excellent | ◯ | 0 |
| Example 6 | | | |

TABLE 4

| | Rate Test (%) | Cycle Test (%) |
|---|---|---|
| Example 1 | 69 | ≧99 |
| Example 2 | 80 | ≧99 |
| Example 3 | 48 | ≧99 |
| Example 4 | 65 | ≧99 |
| Example 5 | 69 | ≧99 |
| Comparative | 23 | 65 |
| Example 1 | | |
| Comparative | 35 | 68 |
| Example 2 | | |
| Comparative | 15 | 51 |
| Example 3 | | |
| Comparative | 45 | 88 |
| Example 4 | | |
| Comparative | 46 | 71 |
| Example 5 | | |
| Comparative | 21 | ≧99 |
| Example 6 | | |

What is claimed is:

1. A positive electrode for lithium secondary batteries, comprising:
a positive-electrode composite including at least a positive-electrode active material and a binder; and
a positive-electrode current collector;
wherein the positive-electrode active material includes a lithium composite oxide having an olivine-type structure, which is represented by the formula LiMnₓM₁₋ₓPO₄ (where 0.3≦x≦1 and M is one or more elements selected from the group consisting of Li, Fe, Ni, Co, Ti, Cu, Zn, Mg, and Zr); and
the binder includes an acrylonitrile-based copolymer.

2. The positive electrode for lithium secondary batteries according to claim 1,
wherein the ratio of the acrylonitrile-based copolymer in the positive-electrode composite is 5-15 mass percentage.

3. The positive electrode for lithium secondary batteries according to claim 1,
wherein the acrylonitrile-based copolymer is a copolymer made from either acrylonitrile or methacrylonitrile and a monomer having an ester group represented by the formula CH₂═CR₁—CO—O—R₂ (where R₁ is H or CH₃, and R₂ is any alkyl group or alkyl chain with a functional group).

4. The positive electrode for lithium secondary batteries according to claim 1,
wherein pH of a supernatant solution is greater than or equal to 11, the solution being obtained by mixing 1 g of the positive-electrode active material with 50 g of purified water, stirring for one minute, and then leaving the mixture at rest for 60 minutes.

5. The positive electrode for lithium secondary batteries according to claims 1,
wherein the positive-electrode active material has a specific surface area of 15-100 m²/g.

6. The positive electrode for lithium secondary batteries according to claim 1,
wherein pH of a supernatant solution is greater than or equal to 11, the solution being obtained by mixing 1 g of the positive-electrode active material with 50 g of purified water, stirring for one minute, and then leaving the mixture at rest for 60 minutes; and
the positive-electrode active material has a specific surface area of 15-100 m²/g.

7. A lithium secondary battery comprising:
a positive electrode;
a negative electrode;
a separator between the positive electrode and the negative electrode; and
an electrolyte;
wherein the positive electrode is the positive electrode for lithium secondary batteries according to claim 1.
